(19) United States
(12) Patent Application Publication
(10) Pub. No.: US 2014/0052663 A1
(43) Pub. Date: Feb. 20, 2014

(54) SYSTEM AND METHOD FOR ELECTRONIC EVALUATION AND SELECTION OF SCHOOLS BASED ON USER INPUTS

(71) Applicant: Milestones Media, LLC, Atlanta, GA (US)

(72) Inventors: Brian KELLEY, Atlanta, GA (US); Amanda Lee ATKINS, Decatur, GA (US); Monica Houle McGURK, Dunwoody, GA (US); Donna Jill PULLEN, Stone Mountain, GA (US); Jason Reid WADE, Atlanta, GA (US)

(73) Assignee: Milestones Media, LLC, Atlanta, GA (US)

(21) Appl. No.: 13/970,145

(22) Filed: Aug. 19, 2013

Related U.S. Application Data
(60) Provisional application No. 61/691,121, filed on Aug. 20, 2012.

(51) Int. Cl. G06Q 30/02; G06Q 50/20

(52) U.S. Cl. CPC G06Q 30/0282; G06Q 50/20
USPC 705/347

(57) ABSTRACT

A system and method for electronically evaluating and selecting schools based on user inputs is provided. The system may include a server for receiving and processing information and preferences of a student provided by a user and databases for storing such information. The system may also receive and process information from alumni and other sources to create a profile for a school. An algorithm provided by the system may be used to provide the user a report and custom ranking of schools based on the student information and preferences, and school profiles.

### CROSS-REFERENCE TO RELATED APPLICATIONS

The present application claims the benefit of priority of the U.S. Provisional Application No. 61/691,121 filed Aug. 20, 2012, which is incorporated herein by reference.

### FIELD OF THE INVENTION

The present invention generally relates to the evaluation of prospective schools based on user inputs using an electronic device.

### BACKGROUND OF THE INVENTION

Selecting a school is often one of the most critical decisions an individual will make during his or her lifetime. The information that one must consider can be overwhelming, and includes more than simply location, cost and degree sought. Often a student or a student's parents are left to make this decision with minimal knowledge and only a general idea if a school will meet the students needs, or if the student has the requirements to be accepted by a school.

### BRIEF SUMMARY OF THE INVENTION

Systems and methods for evaluating and selecting schools based on user inputs are disclosed.

A system accessible via a network by an electronic device, such as a desktop computer, a Smartphone, a tablet computer, a laptop computer, a mobile phone, etc. is disclosed. The system may enable a user to input student's personal information, academic information, desired attributes for a school, desired lifetime attributes to create a student profile.

In one embodiment, the system may use an algorithm to compare the student's profile and/or targeted life outcome to information collected about schools (e.g., colleges, universities, graduate schools, community colleges, college preparatory schools, vocational schools, etc.) to match the student to one or more schools based on student's compatibility with the school's profile. The system may then output a report to the user including the level of compatibility of the student to each identified school.

Although the system is described in the context of a high school student applying to four-year university, it may also be applicable to college students looking to transfer to a new school, college students applying to graduate schools, or college students applying to post-graduation employment, or other types of students applying to other educational opportunities as necessary and/or desired.

### BRIEF DESCRIPTION OF THE DRAWINGS

FIG. 1 is a diagram of the system, showing how different devices may access the server via a network.

FIG. 2 is a diagram of the system showing the different sources of inputs and outputs to the server.

FIG. 3 is a flow chart showing the steps to create a profile for a school

FIG. 4A is a flow chart showing the steps for identifying schools compatible to a student's profile and/or targeted life outcome.

FIG. 4B is a flow chart showing the steps for identifying schools compatible to a student's profile and/or targeted life outcome and further including steps for identifying a student's improvement opportunities.

FIG. 5 is a flow chart showing one embodiment of the school selection process.

### DETAILED DESCRIPTION OF THE INVENTION

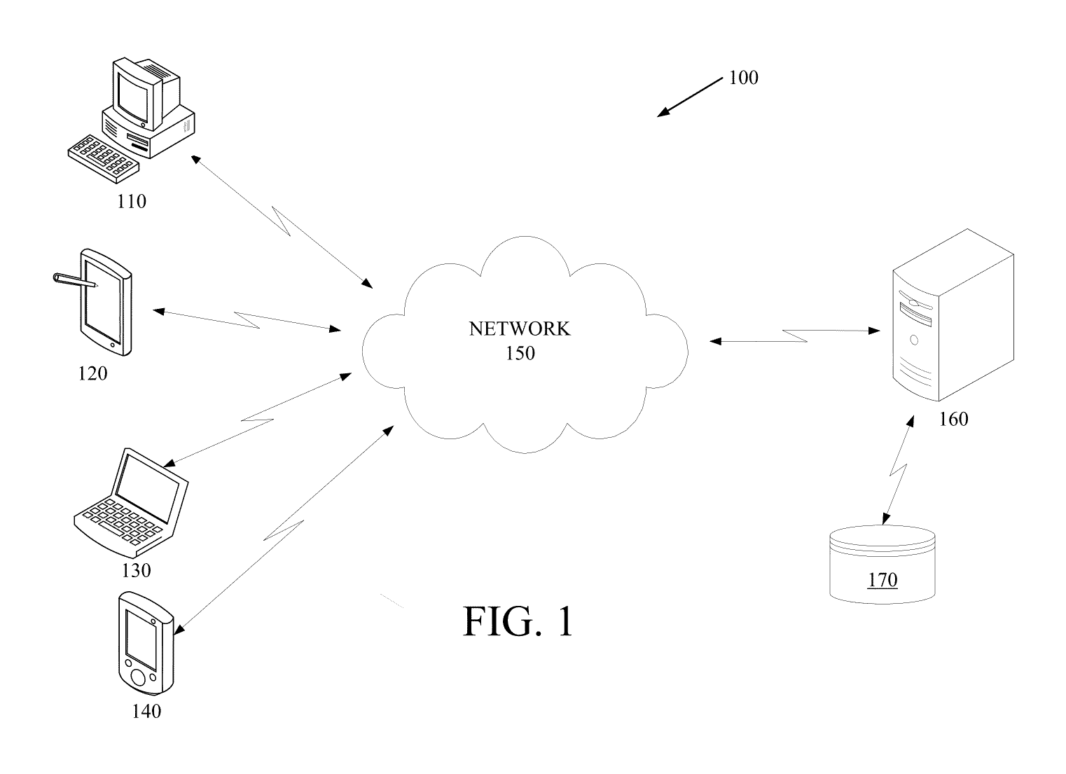

Referring to FIG. 1, a system 100 for evaluating and selecting schools based on user inputs using an electronic device is disclosed. System 100 may include desktop computers 110, tablet computer 120 (e.g., Apple iPad, Samsung Galaxy Tab, etc.), notebook/laptop computers 130 and Smartphones 140 (e.g., Apple iPhone, Motorola Droid, RIM Blackberry, etc.). Each of devices 110, 120, 130 and 140 may access the server 160 via a network 150 (e.g., cellular networks, telephone network, wifi, LAN, the Internet, etc.). Although only one server 160 is illustrated, it should be understood that multiple server 160 may be provided as necessary and/or desired.

In one embodiment, user inputs may be provided by telephone to an automated system provided by the server 160. In another embodiment, user inputs may be provided by telephone to an interviewer who may enter the user inputs through an input device coupled to the server 160 (e.g., a keyboard, a mouse, a terminal, a touchscreen, etc.). In a further embodiment, the interviewer may enter the user inputs via a device 110, 120, 130 or 140 connected to the server 160 via a network 150.

Any suitable communication mechanism may be used as necessary and/or desired to provide user inputs to the server 160.

In one embodiment, server 160 may provide a user interface to be displayed on devices 110, 120, 130 and 140 when connected to the server 160 via a network 150. In one embodiment, the user interface's format and content may be different depending on the device it is displayed on.

In one embodiment, the user interface may be provided by the server 160 as one or more web pages in a web browser (e.g., Microsoft's Internet Explorer, Mozilla's Firefox, Apple's Safari, Google's Chrome, etc.) on a device 110, 120, 130 or 140. In another embodiment the user interface may be provided as an application that may be installed on a device that may connect to the server 160 via a network 150. The application may be provided by the server 160 or an on-line retailer (e.g., Apple's iTunes App Store, Google's Android Market, etc.).

In one embodiment, server 160 may be used for user registration and/or authentication information, storing user settings, creating student profiles, and processing information input using devices 110, 120, 130 and 140.

Database 170 may be provided or accessed by server 160. Although only one database 170 is illustrated, it should be understood that multiple database 170 may be provided as necessary and/or desired. Moreover, database 170 may include both related and third-party services, databases, systems, etc.

In one embodiment, database 170 may include educational institution information databases, student information databases, Alumni information databases, discussion forums, tuition and financial aid calculators, etc. Other databases, such as high school student information databases (e.g., high school student body data, high school demographics, applications and success rates of historical student bodies etc.), may be accessed as necessary and/or desired.

In one embodiment, educational institution information databases included in database 170 may include information about school overall rankings, school rankings based courses and/or degrees, school acceptance rates of past applicants, school demographics of past applicants, targeted student profiles of schools, school acceptance requirements, student graduation statistics, statistics on professions of school graduates, and other related data as necessary and/or desired.

In one embodiment, student information databases in database 170 may include information about student preferences, student transcripts, student job history, student extracurricular activities, student achievements, student referral letters, student endorsements, third party verifications of student information, and other related data as necessary and/or desired.

In one embodiment, data may be stored to and/or accessed by the server 160 from a cloud or other centralized storage (not shown).

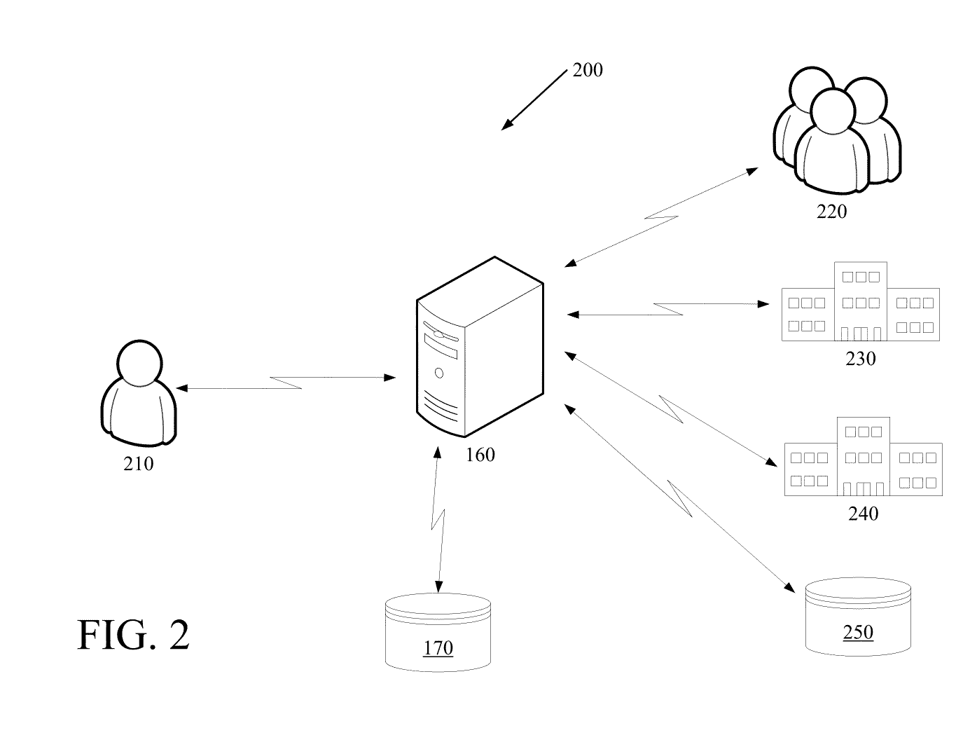

Referring to FIG. 2, system 200 may collect information about a student 210, schools 230, or from a current school 240 of a student 210, or from alumni 220 of schools 230, or external databases 250. This information may be entered via an application, or downloaded by the server 160 and stored on the database 170. Server 160 may also provide feedback to student 210 and/or to the current school 240 of student 210, about schools 230 in which student 210 may be interested. In addition, server 160 may provide feedback to schools 230 about the types of students 210 that are interested in them.

In one embodiment, server 160 may provide a means for alumni 220 to communicate directly with student 210 regarding the alumni's schools 230 via an electronic forum or the like.

In one embodiment, external databases 250 may include other services and databases such as state and national databases for school rankings and course difficulty, student and faculty demographic data, historical weather data, topographical data, neighborhood data (e.g., demographics, crime rates, cost of living, etc.), school amenities information (e.g., dorms and off campus housing availability, dorm quality, campus dining quality, sports facilities, etc.), school statistics (e.g., courses and majors available, faculty ratings and evaluations, cost, debt loads of students, default rates on student loans, student job placement rates, recruiter ratings and evaluations, etc.), social networking information (e.g., Facebook, Twitter, Yelp, Pinterest, etc.). Other external databases may be accessed as necessary and/or desired.

In one embodiment, school administrators, faculty, alumni, etc. may also provide information about the school.

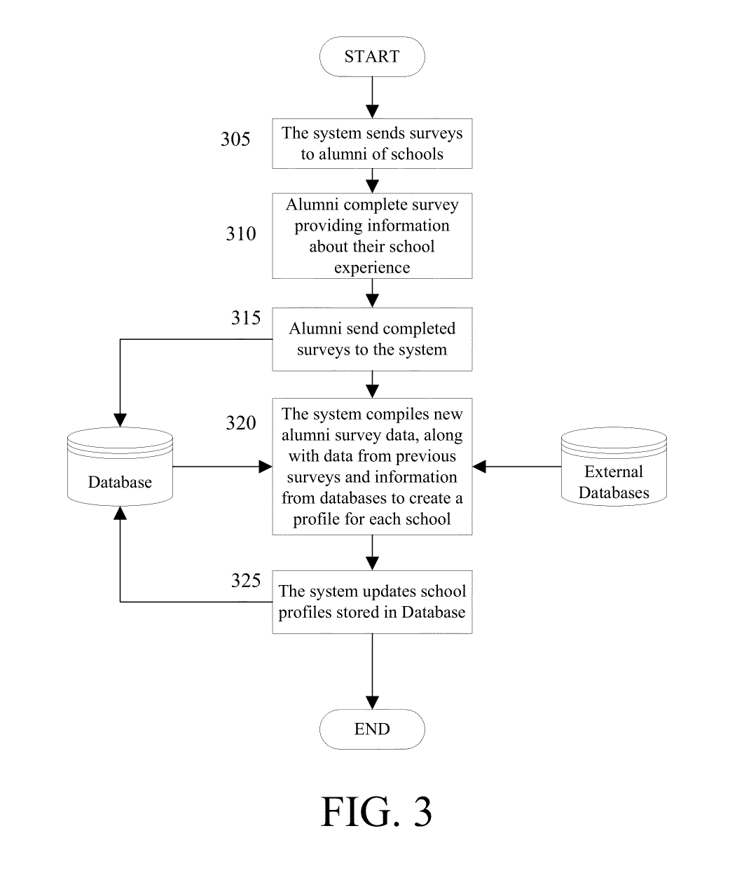

Referring to FIG. 3, one embodiment of a method of system for collecting information about schools is diagramed in a flow chart. In step 305, the system may send surveys from a database to the alumni of schools. In step 310, the alumni may complete the surveys, providing information regarding their experience at schools and post-graduation outcomes (e.g., student life, curriculum difficulty, faculty interactivity, quality dormitory life, post-graduate experience, intellectual development, spiritual development, social development, communication skills development, friendship development, friendship longevity, leadership skills development, innovation and creativity development, community service, community leadership, career preparation, immediate job opportunities, alumni giving, willingness to recommend, interest attending again, debt load, post-graduate employment income, profession, wealth building, sustainability of employment, political views, social views, happiness, overall assessment of their experience, etc.). In step 315, the alumni may send the completed survey information to the system. In step 320, the system may compile the newly received alumni survey data, together with data from previous alumni surveys stored on the database, and information from external databases to create a profile, an overall ranking and ranking for each measured factor for each school. In step 325, the new or updated school profiles may be stored on a database.

In one embodiment, an alumnus' status with a school may be verified prior to sending surveys to the alumnus. For example, alumni status may be verified by checking with schools, alumni associations or similar organizations. In another embodiment an alumnus' status may be validated and/or cross-checked against their personal information disclosed on various platforms (e.g. Facebook, LinkedIn, Monster, CareerBuilder, etc.).

In one embodiment, surveys may be mailed to the alumni and returned via mail. In another embodiment, the surveys are completed electronically on an user interface provided by the system. In another embodiment, the alumni may choose to have the survey mailed to them or to complete the survey online via an user interface provided by the system. In another embodiment alumni may be contacted by telephone and/or call in to a provided phone number to take a survey.

In one embodiment, schools may send alumni a code for accessing a survey

In one embodiment, the user interface for alumni surveys may be the same user interface as the user interface for entering student information. In another embodiment the student information user interface and the alumni user interface may be different user interfaces.

In one embodiment, the system may store to and/or access individual alumni surveys from a database, a cloud or other centralized storage.

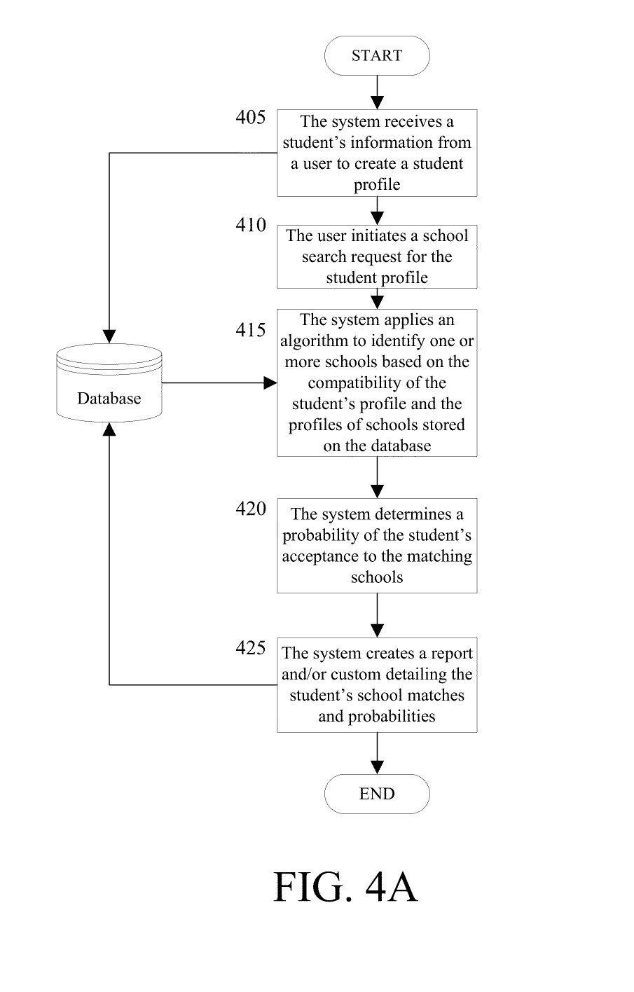

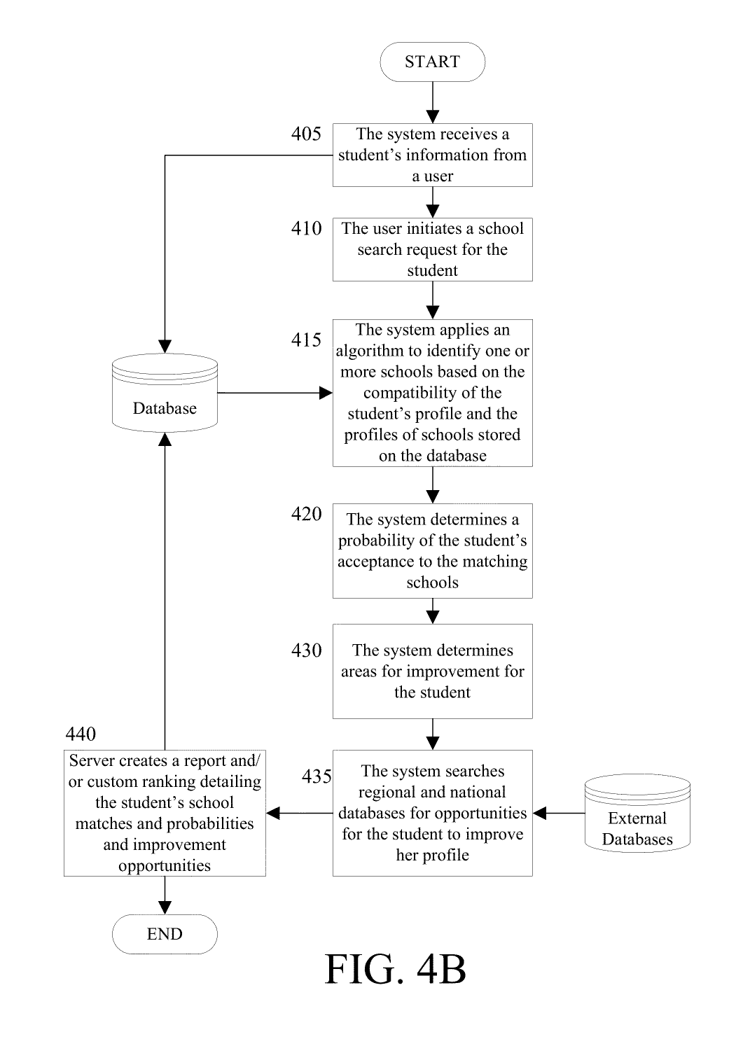

Referring to FIG. 4A, a method for identifying schools that may be compatible with a students goals and preferences according to one embodiment is provided. In step 405, the system may receive information submitted by a user (e.g., the student, the student's parent, a relative of the student, the student's high school guidance counselor, a combination thereof, etc.) about the student. The information may be the student's personal information (e.g., name, age, sex, race, address, number and age of siblings, personality profile, etc.), academic information (e.g., grades, classes, standard test scores, awards, leadership positions, sports, extracurricular activities, community service, etc.), employment information, references, endorsements, family information (e.g., parent's financial situation, parent and/or sibling educational history, schools attended by friends and/or relatives, etc.), desired attributes for a school (e.g., school size, academics, geography, college town or urban school, cost range, financial aid availability, majors, degrees, etc.), desired lifetime attributes (e.g., career preference, income, friendships, etc.), or any other information as necessary and/or desired. The information submitted by the user to the system may be used to create a profile for the student.

In step 410, the user may request the system to initiate a school search based on a specified student profile.

In step 415, the system may apply an algorithm to identify one or more schools based on the compatibility of the student's profile and the profiles of schools stored on the database.

In step 420, the system may determine the student's probability of gaining admission into the identified compatible schools, and the school's probability in meeting the students desires and goals.

In step 425, the system may create a report and/or custom ranking detailing the results of the search to be provided to the user. The report and/or custom ranking may include an overall ranking, ranking by key attributes, ranking by probability of acceptance to schools, ranking by probability of schools meeting a student's lifetime goals, or any necessary and/or desired output or any combination thereof.

Referring to FIG. 4B, a method of for identifying schools that may be compatible with a students goals and preferences including identifying a student's improvement opportunities according to one embodiment is provided. Steps 405-420 may be similar to those described in FIG. 4a.

In step 430, the system may identify areas that may need improvement in a student's profile (e.g., wrong courses in general, lack of AP or advanced courses, low grade point average, low or out of range standardized test scores, low grades in a particular subject, attending an atypical school, lack of community service, lack of extracurricular activities, lack of leadership positions, weak references, lack of arts and/or public service awards, student residency is out of state, incompatible demographic profile, etc.).

In step 435, the system may search various databases for opportunities for the student to improve her profile. For example databases may be searched for SAT review course, standardized test schedules to retake test, tutors, course offerings at a high school or community college, academic or arts related contests and/or recognition programs, volunteer opportunities, youth sports leagues, or other improvement opportunities as necessary and/or desired.

In step 440, the system may create a report and/or custom ranking detailing the results of the search to be provided to the user. The report and/or custom ranking may include an overall ranking, ranking by key attributes, ranking by probability of acceptance to schools, ranking by probability of schools meeting a student's lifetime goals, a student's deficiency areas, improvement opportunities identified to alleviate identified deficiencies, or any necessary and/or desired output or any combination thereof.

In one embodiment the system may provide one or more links with the report and/or custom ranking for a student. In another embodiment the one or more links may include links to school websites, improvement opportunity websites, discounts, promotions, etc.

In one embodiment, the student profile may be stored in a database. In another embodiment, the student profile may be stored on a user's device. In another embodiment, the user's search results may be stored in database. In another embodiment, the user search results may be stored on a user's device.

In one embodiment, the results of user searches may be provided to schools to assist them in identifying the demographics of students interested in the school or similar schools.

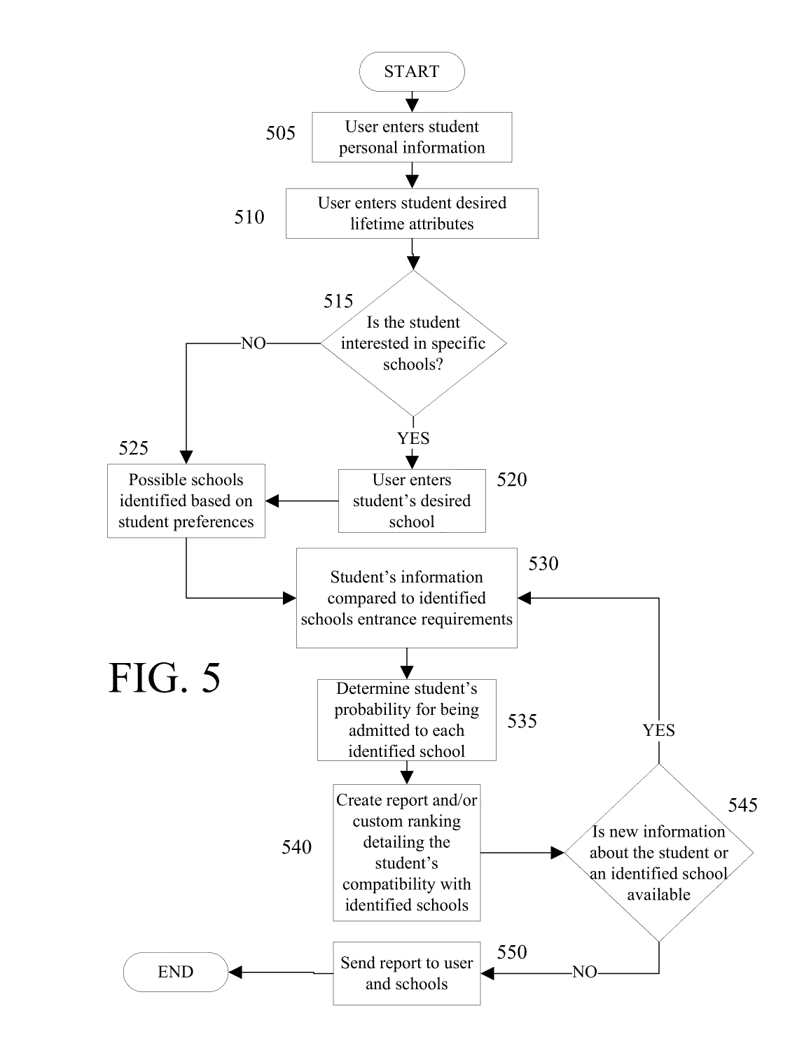

Referring to FIG. 5, a method for evaluation and selection of schools based on user inputs according to one embodiment is provided. The system, may allow a user to enter a student's personal information and the student's desired life time attributes in steps 505 and 510.

In step 515, the system may confirm if a student is interested in specific schools. In step 520, if the student is interested in specific schools the user may identify any such schools.

In step 525, after the user enters the schools in which the student may be interested, or if no schools are specified, the system may identify one or more schools that may match the student's preferences.

In step 530, the student's information may then be compared to the identified schools' entrance requirements.

In step 535, the student's probability of being admitted to each possible match schools may be determined.

In step 540, a report may be created detailing the student's compatibility with identified schools.

In step 545, the system may check if there is new information available about the student or an identified school. If new information is available steps 530-545, may be repeated as necessary and/or desired.

In step 550, if no new information is available, the report created in step 540 may be displayed or transmitted to the user and/or identified schools.

In one embodiment, the created report may also detail if attending a school will assist the student in meeting the student's desired lifetime attributes.

In one embodiment, the user may enter a student's information manually. In another embodiment, the student's information may be received electronically from the student's current school (e.g., high school, preparatory school, college, etc.). In another embodiment, the student's information may be extracted from transcripts that may be scanned. In still another embodiment, the student's information may be entered using a combination of manual entry, electronic entry and scanning.

In one embodiment, the system may provide the user with the ability to establish one or more user profiles for a student. The user may enter a student's requirements (or a range of requirements) for a school (e.g., overall ranking, ranking elements that the student has identified as important, tuition cost range, types of degrees available, distance from home, faculty to student ratio, ranking of school, scholarship availability, financial aid availability, etc.), preferred and/or prohibited elements (e.g., geographic region, school size, school religious affiliation, faculty or school political affiliations, extracurricular activities, suburban/urban locations, public/private schools, male to female ratio, racial composition of student body, Greek life, on/off campus living, quality of facilities, safety/crime rate, acceptance of students with alternative lifestyles, etc.), and other requirements or preferences as necessary and/or desired.

In one embodiment, the all or part of a student's profile may be derived from the profiles of schools in which the student has indicated they interested.

In one embodiment, the user may be able to assign an importance, or desirability, score to each element. For example, the user may rank the importance of each element to the student as high, medium, or low; on a scale from 1-10; on a scale from 1-100; a toggle bar or slider indicating more vs. less importance; conjoint analysis; choosing preferred elements from multiple pairs of related and/or dissimilar elements (e.g., having the user choose between a public or private school, having the user choose between Greek life or urban location, etc.); or by using any suitable ranking methodology as necessary and/or desired.

In one embodiment, the system may provide the user with the ability to specify one or more schools (or types of schools) the student may be interested in attending. If more than one school is specified the user may rank the schools in order of the students preference.

In one embodiment, multiple profiles may be established for a student. For example, the student, the student's parents, and the student's high school guidance counselor may complete separate profiles. The system may apply the profiles individually, or it may determine common elements from the profiles to establish a single, reconciled profile. In one embodiment, each completed profile may be weighted differently.

In one embodiment the system may rank schools specified by the user as being of interest to the student based on the student's preferences, the student's one or more profiles, the profiles or preferences of similar students as necessary and/or desired.

In one embodiment, schools may participate by providing information to the system. For example a school may provide additional data to the system about students that are accepted to the school each semester.

In one embodiment, alumni of schools may provide information to the system. For example they may fill out a survey rating their experience at their school in general, or they may provide specific information about classes and student life.

In one embodiment, the system may provide a real-time comparison of a student's probability of gaining admission into one or more schools. As a student's information is updated (e.g., the student's goals change, updated GPA, new standardized test scores, etc.) and/or a school's entry requirements change, the system may revise the list of recommended schools, and student's probability in gaining admission to the schools.

In one embodiment, the system may also provide a “point system” so the user has an idea how the student's profile compares to a student that is likely to be accepted at schools (or has been admitted). This may be based on, for example, historical information from the database, or from information provided by schools, or from information collected from other users. For example, the student may receive points for academic achievements, leadership positions, sports, extracurricular activities, community service, etc. The system may make suggestions to the user so the student can improve her profile and increase the likelihood of acceptance.

In one embodiment, the system may monitor events or resources in a geographic area for things that could improve a student's chances for admission to a school. For example, the system may monitor an area for available tutors in a subject in which a student is deficient, and/or monitor for public service opportunities (e.g., volunteering opportunities at soup kitchens, the Special Olympics, Ronald McDonald House, etc.) in an area.

In one embodiment, the system may provide a means for third parties (e.g. teachers, guidance counselors, employers, community leaders, etc.) to submit references or endorsements of a student that may be provided to one or more schools listed in the student's profile.

In one embodiment, the system may use predictive modeling to provide an assessment of the likelihood of school acceptance, and a school meeting a student's goals and desires, etc.

In one embodiment, the system may create historical database of student profiles and acceptance data that is independent of school data. For example, the system may store profile data for students that apply to particular schools, and note whether or not those students were accepted. From this data, the system may make an independent assessment of whether a student is likely to be accepted, characteristics that a school desires, etc.

In one embodiment, the system may create historical database of student profiles and lifetime goal achievement data that is independent of school data. For example, the system may store profile data for students that attend particular schools, and note whether or not those students achieve their lifetime goals by attending a school. From this data, the system may make an independent assessment of whether a student is likely to achieve their lifetime goals by attending the school.

In one embodiment, the system may also provide a “recommendation engine” that can recommend schools to a student based on schools already on that student's list based on common drivers of preference. For example, the recommendation engine may sort schools on a student's list to identify common attributes that may be used as a student's preferences (e.g. schools success of generating specific life outcomes, common majors, available extracurricular activities, study abroad opportunities, common geography, common student body demographics, similar costs, similar academic calendars, etc.), and scan a database for similar schools based on one or more of the identified preferences that may be then suggested as possible matches to the student or user.

In one embodiment, the recommendation engine may scan a database for one or more other students with similar profiles to the student and recommend to the student the schools selected by the one or more other students with similar profiles. In another embodiment, the similar student profiles may be drawn from a historical database of previous students.

In one embodiment, the system may pre-populate all or part of a student's school application forms for schools based on the information provided in the student's profile.

In one embodiment, the system may identify alumni who are interested in communicating with students about the alumni's schools.

In one embodiment, the system may put users and/or students in contact with alumni from one or more schools the student is interested in or matched with. The communication between alumni and students/users may be on forums provided by the system, secure email through the system, voice calls through the system, or any other communication means as necessary and/or desired.

In one embodiment, the system may provide an alumni outreach program for schools to communicate with their respective alumni.

In one embodiment, the system may provide a means for pairing students interested in a particular school with alumni from the school as part of a mentoring and/or recruiting program. For example, a student interested in a school may activate a link in the user interface to show their interest in communicating with alumni of the school.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ 8 operating system, the Microsoft Windows™ 7 operating system, the Microsoft Windows™ Vista™ operating system, the Microsoft Windows™ XP™ operating system, the Microsoft Windows™ NT™ operating system, the Windows™ 2000 operating system, an Mac OSX operating system, an Apple iOS operating system, a Unix operating system, a Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, a Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What we claim is:

1. A computer implemented method for electronic evaluation and selection of schools based on user inputs comprising:
receiving, at a first interface, information about a student;
receiving, at a second interface, a request from the user to initiate a school search based on the information;
using at least one a plurality of computer processors, identifying one or more schools based on the information and profiles of one or more schools stored on a database;
using at least one of the plurality of computer processors, determining the student's probability of gaining admission into the one or more identified compatible schools;
using at least one of the plurality of computer processors, creating at least one of a report and a custom ranking detailing the student's probability of gaining admission into the one or more identified schools; and
providing the at least one of a report, and a custom ranking to the user.

2. The computer implemented method of claim 1, wherein the information submitted by a user about a student is used to create a student profile.

3. The computer implemented method of claim 2, wherein the student profile is stored on a database.

4. The computer implemented method of claim 2, further comprising:
determining areas for improvement for the student;
searching at least one database to identify one or more opportunities for the student to improve her profile; and
providing a list of the identified one or more opportunities to the user.

5. The computer implemented method of claim 1, wherein the step of identifying one or more schools based on the information and profiles of one or more schools stored on a database, comprises using the at least one of the plurality of processors, applying an algorithm to identify one or more schools based on the information and profiles of one or more schools stored on a database.

6. A computer readable medium storing instructions that, when executed by at least one of a plurality of computer processors, causes the at least one processor to perform the steps of:
receive information about a student;
receive a request from the user to initiate a school search based on the information;
identify one or more schools based on the information and profiles of one or more schools stored on a database;
determine the student's probability of gaining admission into the one or more identified schools;
create at least one of a report and a custom ranking detailing the student's probability of gaining admission into the one or more identified compatible schools; and
provide the at least one of a report, and a custom ranking to the user.
